(19) United States
(12) Patent Application Publication
(10) Pub. No.: US 2026/0327132 A1
(43) Pub. Date: Oct. 22, 2026

(54) COAL GASIFICATION SLAG SOLID WASTE CEMENTITIOUS MATERIAL AND PREPARATION METHOD THEREOF

(71) Applicant: Northeastern University, Shenyang (CN)

(72) Inventors: Xiaowei GU, Shenyang (CN); Xiaowei GE, Shenyang (CN); Xiaochuan XU, Shenyang (CN); Zhihang HU, Shenyang (CN); Fengdan WANG, Shenyang (CN); Ziyang HU, Shenyang (CN); Xu WANG, Shenyang (CN); Shenyu WANG, Shenyang (CN); Bohan YANG, Shenyang (CN); Jianping LIU, Shenyang (CN); Qing WANG, Shenyang (CN); Hao WANG, Shenyang (CN)

(21) Appl. No.: 19/693,373

(22) Filed: May 30, 2026

(30) Foreign Application Priority Data
Oct. 31, 2025 (CN) 202511581256.0

(51) Int. Cl. C04B 18/06; C04B 5/00; C04B 40/00; C04B 40/02

(52) U.S. Cl. CPC C04B 18/067; C04B 5/00; C04B 18/061; C04B 40/0042; C04B 40/0067; C04B 40/02; C04B 2201/50

(57) ABSTRACT

A coal gasification slag all-solid waste cementitious material and a preparation method thereof belong to the field of comprehensive utilization of resources and mining technology, the coal gasification slag all-solid waste cementitious material and the preparation method thereof adopt coal gasification slag, granulated blast furnace slag, desulfurization ash, desulfurization gypsum, carbide slag, and other mine or industrial solid waste with low cost. After resource utilization, the problem of solid waste accumulation is effectively solved, and the pressure on the ecological environment is reduced. A process of calcination and activation of coal gasification slag without auxiliary fuel is proposed, the calcination temperature is 400-500 °C. The high content residual carbon in coal gasification slag is used to provide the heat value of calcination, reduce the external energy consumption, and enhance the combustion rate.

### TECHNICAL FIELD

The present disclosure belongs to the field of comprehensive utilization of resources and mining technology, and specifically relates to a coal gasification slag solid waste cementitious material and a preparation method thereof.

### BACKGROUND

The coal gasification process is a crucial technology for converting coal into syngas, and it is widely applied in the chemical industry, electric power generation, and other industrial sectors. Coal gasification slag is a by-product generated during the coal gasification process, comprising coarse slag discharged from the gasifier outlet (accounting for 60%-80%) and fine slag collected from the dust removal system (accounting for 20%-40%). At present, the annual emission of coal gasification slag exceeds 50 million tons and exhibits an exponential growth trend, which seriously impacts the local ecological environment. Achieving the large-scale and high-value utilization of coal gasification slag has therefore become an urgent issue to be addressed. Coal gasification slag itself contains more than 70% of an amorphous silicon-aluminum phase, which possesses potential cementitious reactivity. Preparing cementitious materials from this slag for applications such as mine backfilling, roadbed construction, and other engineering fields represents an effective approach for its large-scale treatment. However, coal gasification slag suffers from a high residual carbon content and low reactivity, which restricts its further application.

In view of these challenges, the present disclosure adopts a calcination modification method to develop a novel all-solid-waste cementitious material based on coal gasification slag. Calcination of raw materials serves as an effective means to improve their reactivity. For example, CN112758955B and CN114804672B also describe processes involving the co-calcination of raw materials with alkalis or alkali metals (alkali fusion method). In contrast, the innovation of the present disclosure lies in achieving the calcination of coal gasification slag without the use of auxiliary fuel, thereby reducing external energy consumption by harnessing the calorific value (approximately 16 MJ/kg) provided by the high residual carbon content present in the fine slag. By optimizing the calcination temperature (400-500 °C), the degree of polymerization of the amorphous silicon-aluminum phase in the coal gasification slag is reduced, and the resulting material is applied to the preparation of all-solid-waste cementitious materials. On the one hand, this approach enables the rational and large-scale utilization of the amorphous silicon-aluminum phase within coal gasification slag, thereby mitigating the problem of solid waste accumulation. On the other hand, employing all-solid-waste materials as a substitute for cement reduces the adverse environmental impacts associated with cement production, thus opening up a new pathway for the comprehensive utilization of coal gasification slag. This advancement holds significant theoretical importance and practical application value.

### SUMMARY

The purpose of the present disclosure is to overcome the shortcomings of the above existing technologies and to provide a coal gasification slag solid waste cementitious material and a preparation method thereof.

In order to achieve the above goals, the present disclosure adopts the following technical scheme:

A coal gasification slag solid waste cementitious material, including a composite powder and water; the composite powder includes calcined coal gasification slag/coal gasification coarse slag, granulated blast furnace slag, sodium-based desulfurization ash and carbide slag, according to a mass ratio, the calcined coal gasification slag/coal gasification coarse slag:granulated blast furnace slag:sodium-based desulfurization ash:carbide slag=(30-40):(40-45):(12-15):(7-10), where the calcined coal gasification slag is obtained by mixing the coal gasification coarse slag and the coal gasification fine slag according to a mass ratio of (6:4)-(8:2).

An amount of water added is based on the composite powder, and a mass of water added is 40-60% of a mass of the composite powder.

The composite powder is mixed and ground by a ball mill, and a fineness reaches a control requirement of cement fineness in GB/T1345-2005 Cement fineness test method (80 μm sieve analysis method), a specific surface area of the composite powder is 450-530 m²/kg.

A preparation method for the coal gasification slag solid waste cementitious material includes the following steps:

Step 1, coal gasification slag calcination treatment:
mixing, crushing, and grinding the coal gasification coarse slag and fine slag, and placing treated coal gasification slag into a muffle furnace for high-temperature calcination, after a material is naturally cooled, grinding the material to a size of less than or equal to 80 μm to obtain calcined coal gasification slag.

Step 2, powder mixing:
according to a ratio, mixing the calcined coal gasification slag/coal gasification coarse slag, granulated blast furnace slag, sodium-based desulfurization ash, and carbide slag to form a composite powder, and stirring the composite powder evenly.

Step 3, preparation of a semi-finished product:
according to the ratio, adding water to the composite powder, mixing and stirring evenly by a mixer, then injecting into a mold, vibrating for 1-2 min to eliminate bubbles, and then sealing the mold to prevent water evaporation, and placing it in a curing box for curing.

Step 4, maintenance:
demoulding the semi-finished product after curing to obtain a test block, and placing the block in a water curing tank for curing.

The preparation method for the above-mentioned alkali-melted coal gasification slag solid waste cementitious material, in which:

In Step 1, crushing and mixing the coal gasification coarse slag with coal gasification fine slag according to a mass ratio of (6:4)-(8:2), after grinding for 60 min, calcining in a muffle furnace; the calcination conditions are as follows: the material is heated to 400-500 °C at a heating rate of 10-15 °C/min, and then heat preservation is performed for 2-3 h.

In Step 2, according to a mass ratio, calcined coal gasification slag/coal gasification coarse slag:granulated blast furnace slag:sodium-based desulfurization ash:carbide slag according to (30-40):(40-45):(12-15):(7-10) to form a composite powder.

In Step 3, the amount of water added is 40-60% of the mass of the composite powder. The curing temperature is 20±2 °C, and the humidity is 90±2 RH %.

In Step 4, a curing temperature is 20±2 °C and a curing time is 3-28 d, a 3 d compressive strength of a coal gasification slag all-solid waste cementitious material prepared is up to 30.6 MPa, and a 28 d compressive strength is up to 45.5 MPa.

The key points of the technical scheme of the present disclosure are as follows:
1, through the preceding analysis, it has been established that the highly polymerized amorphous aluminosilicate glass phase present in coal gasification slag constitutes the primary cause of its low cementitious reactivity, and that the elevated residual carbon content remaining after the coal gasification reaction further retards the hydration process during the preparation of cementitious materials. Consequently, pretreatment is necessary. The coal gasification coarse slag (with a residual carbon content of 10%-20%) and the coal gasification fine slag (with a residual carbon content of 40%-60%) are blended and subjected to calcination. The substantial calorific value derived from the high residual carbon content within the coal gasification slag is harnessed as an energy source, thereby promoting combustion, reducing overall energy consumption, and enabling simultaneous carbon removal and activation without the need for auxiliary fuel during calcination. The selection of appropriate calcination temperature and duration has been substantiated through systematic research and experimentation. Industrial trials involving coal have demonstrated that the residual carbon in coal gasification slag undergoes complete decomposition upon calcination at 400-500 °C. Conversely, ash calcined at 700 °C exhibits a pronounced degree of crystallization of iron-bearing phases, and experimental verification confirms a subsequent decline in reactivity. Therefore, judicious selection of the calcination temperature allows for effective modulation of the degree of polymerization of the amorphous aluminosilicate glass phase within the coal gasification slag, thereby enhancing its reactivity.
2, following calcination and decarbonization, the abundance of active components in the coal gasification slag is significantly increased. Sodium-based desulfurization ash and carbide slag are compounded to serve as solid waste activators. The hydration products of the resulting cementitious material predominantly consist of calcium silicate (calcium aluminate) hydrates, monosulfate phases, and calcium carbonate. The calcined coal gasification slag markedly influences the fluidity of the slurry and can undergo solidification at ambient temperature when combined with granulated blast furnace slag. If the precursor content is excessively low, the reaction system will lack sufficient calcium, silicon, and aluminum species necessary for the formation of the desired reaction products. Conversely, if the dosage of the activators (sodium-based desulfurization ash and carbide slag) is inadequate, the alkalinity of the hydration environment will be diminished, depriving the cementitious reaction of its essential driving force and thereby impeding the formation of reaction products. Furthermore, the composition of the hydration products, including the relative proportions of calcium silicate (calcium aluminate) hydrates and monosulfate phases, as well as the temporal window during which substantial precipitation occurs, directly influences the strength development of the cementitious material. Accordingly, the proportions of the composite powder have been rationally optimized and validated through experimental investigation.

The beneficial effects of the present disclosure are as follows:
(1) The method for preparing an all-solid-waste cementitious material from coal gasification slag utilizes a substantial quantity of coal gasification slag. The raw material constitutes a low-cost by-product of the coal gasification industry. Its resource-oriented utilization not only conserves considerable land resources but also alleviates the environmental burden imposed by the massive accumulation of coal gasification slag.
(2) The cementitious materials produced via the method for preparing an all-solid-waste cementitious material from coal gasification slag are derived entirely from solid wastes, and the raw materials are widely accessible. The coal gasification slag is processed through calcination without the use of auxiliary fuel, capitalizing on the calorific value supplied by its high residual carbon content to enhance product characteristics, improve combustion efficiency, and curtail external energy input. The energy requirement is substantially lower than that necessitated for cement production, thereby aligning with pertinent national policies on energy conservation and emission reduction.
(3) The mechanical properties of the cementitious material obtained through the method for preparing a solid-waste cementitious material from coal gasification slag comply with relevant national standards. The 3-day compressive strength reaches up to 30.6 MPa, while the 28-day compressive strength attains a maximum of 45.5 MPa.

### BRIEF DESCRIPTION OF THE DRAWINGS

FIG. 1 is an XRD pattern of coal gasification coarse slag before and after calcination; and

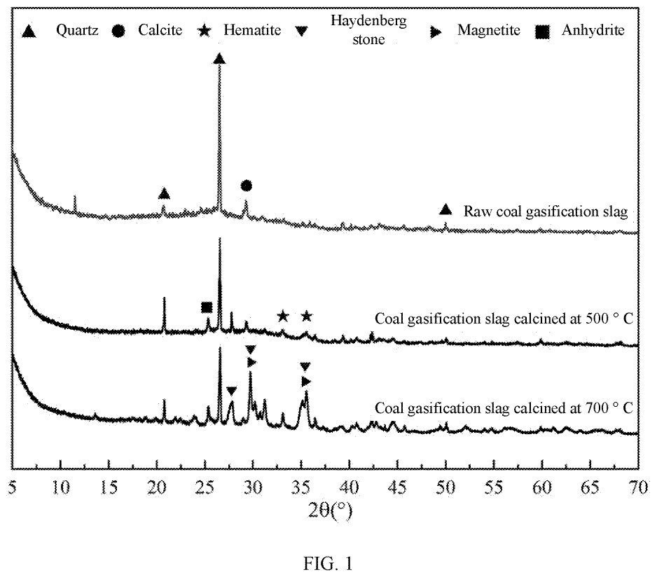

FIG. 2 is an FTIR diagram of coal gasification coarse slag before and after calcination.

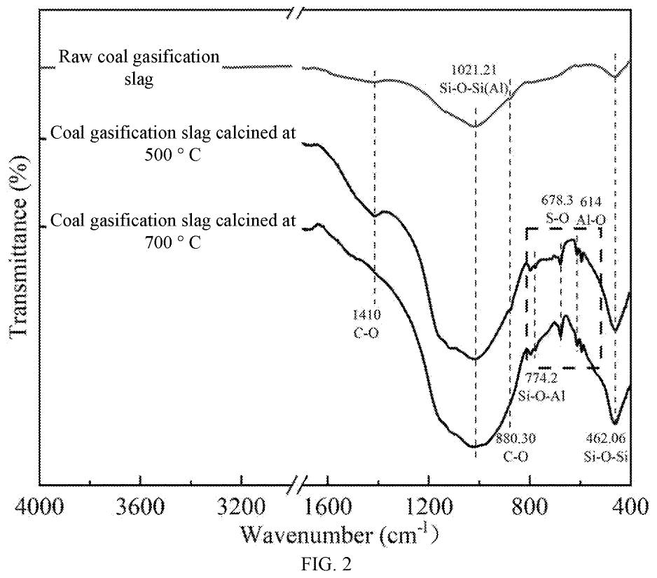

### DETAILED DESCRIPTION

The following is a further detailed description of the present disclosure in combination with implementation examples.

The square mold specification is 40×40×40 mm;

The composition of the coal gasification slag used in the example of the present disclosure includes the mass percentage: SiO₂ 46.4%, CaO 17.38%, Al₂O₃ 16.51%, Fe₂O₃ 10.66%, SO₃ 3.01%, K₂O 2.54%, MgO 1.12%, TiO₂ 0.98%.

### Example 1

A coal gasification slag all-solid waste cementitious material, including composite powder and water. The composite powder includes calcined coal gasification slag, granulated blast furnace slag, sodium-based desulfurization ash, and carbide slag. The calcined coal gasification slag is prepared by mixing and calcining the coal gasification coarse slag and the coal gasification fine slag at a mass ratio of 8:2. According to the mass ratio, the calcined coal gasification slag:granulated blast furnace slag:sodium-based desulfurization ash:carbide slag=30:45:15:10; the amount of water added is based on the composite powder, which is 40% of the mass of the composite powder.

The preparation method for the coal gasification slag all-solid waste cementitious material includes the following steps:

Step 1, coal gasification slag mixed calcination:

The coal gasification coarse slag and coal gasification fine slag are mixed evenly according to the mass ratio of 8:2, and then placed into the planetary ball mill at a speed of 300 rpm/min for 60 min. The milled material is placed in a mullite crucible in a muffle furnace, heated to 400 °C at a heating rate of 10 °C/min, and then held for 3 h to stop heating. After the material is naturally cooled in the furnace, the calcined coal gasification slag is obtained by using a planetary ball mill to 80 μm.

Step 2, powder mixing:

According to the mass ratio, the calcined coal gasification slag:granulated blast furnace slag:sodium-based desulfurization ash:carbide slag=30:45:15:10. The calcined coal gasification slag, granulated blast furnace slag, sodium-based desulfurization ash and carbide slag are mixed to form a composite powder, and the composite powder is stirred evenly.

Step 3, preparation for the semi-finished product:

Water is added to the composite powder, the mass of water added is 40% of the mass of the composite powder, mixed and stirred evenly, and then injected into a 40×40×40 mm cube mold, vibrated on a vibrator for 2 min to eliminate bubbles, wrapped the mold with polyvinyl chloride plastic film, and placed in a curing box for curing, the curing temperature is 20±2 °C and the humidity was 90±2RH %.

Step 4, maintenance:

After curing for 24 h, the semi-finished product is demoulded to obtain the test block, the test block is placed in a water curing box for 3-28 d, and the curing temperature is 20±2 °C, the 3 d compressive strength of the prepared coal gasification slag solid waste cementitious material reached 30.6 MPa, and the 28 d compressive strength reaches 45.5 MPa, the slump of the prepared cementitious material slurry is 197 mm.

### Example 2

A coal gasification slag all-solid waste cementitious material, including composite powder and water. The composite powder includes calcined coal gasification slag, granulated blast furnace slag, sodium-based desulfurization ash and carbide slag. The calcined coal gasification slag is prepared by mixing and calcining the coal gasification coarse slag and the coal gasification fine slag at a mass ratio of 8:2. According to the mass ratio, the calcined coal gasification slag:granulated blast furnace slag:sodium-based desulfurization ash:carbide slag=40:40:12:8; the amount of water added is based on the composite powder, which is 50% of the mass of the composite powder.

The preparation method for the coal gasification slag all-solid waste cementitious material includes the following steps:

Step 1, coal gasification slag mixed calcination:

The coal gasification coarse slag and coal gasification fine slag are mixed evenly according to the mass ratio of 8:2, and then placed into the planetary ball mill at a speed of 300 rpm/min for 60 min. The milled material is placed in a mullite crucible in a muffle furnace, heated to 400 °C at a heating rate of 10 °C/min, and then held for 3 h to stop heating. After the material is naturally cooled in the furnace, the calcined coal gasification slag is obtained by using a planetary ball mill to 80 μm.

Step 2, powder mixing:

According to the mass ratio, the calcined coal gasification slag:granulated blast furnace slag:sodium-based desulfurization ash:carbide slag=40:40:12:8; the calcined coal gasification slag, granulated blast furnace slag, sodium-based desulfurization ash and carbide slag are mixed to form a composite powder, and the composite powder is stirred evenly.

Step 3, preparation of the semi-finished product:

Water is added to the composite powder, and the mass of water added is 50% of the mass of the composite powder, the mixture is stirred evenly, and then injected into a 40×40×40 mm cube mold, the mold is vibrated on a vibrator for 2 min to eliminate bubbles, the mold is wrapped with polyvinyl chloride plastic film and placed in a curing box for curing, the curing temperature is 20±2 °C and the humidity is 90±2RH %.

Step 4, maintenance:

After curing for 24 h, the semi-finished product is demoulded to obtain the test block. The test block is placed in a water curing box for 3-28 d, and the curing temperature is 20±2 °C. The 3 d compressive strength of the prepared coal gasification slag solid waste cementitious material reaches 25.6 MPa, and the 28 d compressive strength reaches 36.5 MPa, the slump of the prepared cementitious material slurry is 215 mm.

### Example 3

An coal gasification slag all-solid waste cementitious material, including composite powder and water, the composite powder includes calcined coal gasification slag, granulated blast furnace slag, sodium-based desulfurization ash and carbide slag, the calcined coal gasification slag is prepared by mixed calcination of coal gasification coarse slag and coal gasification fine slag at a mass ratio of 6:4. According to the mass ratio, the calcined coal gasification slag:granulated blast furnace slag:sodium-based desulfurization ash:carbide slag=40:40:12:8; the amount of water added is based on the composite powder, which is 60% of the mass of the composite powder.

The preparation method for the coal gasification slag all-solid waste cementitious material includes the following steps:

Step 1, coal gasification slag mixed calcination:

The coal gasification coarse slag and coal gasification fine slag are mixed evenly according to the mass ratio of 6:4, and then placed into a planetary ball mill to grind at a speed of 300 rpm/min for 60 min, the milled material is placed in a mullite crucible in a muffle furnace, heated to 500 °C at a heating rate of 10 °C/min, and then held for 3 h to stop heating. After the material is naturally cooled in the furnace, the calcined coal gasification slag is obtained by using a planetary ball mill to 80 μm.

Step 2, powder mixing:

According to the mass ratio, the calcined coal gasification slag:granulated blast furnace slag:sodium-based desulfurization ash:carbide slag=40:40:12:8, the calcined coal gasification slag, granulated blast furnace slag, sodium-based desulfurization ash and carbide slag are mixed to form a composite powder, and the composite powder is stirred evenly.

Step 3, preparation of the semi-finished product:

Water is added to the composite powder, and the mass of water added is 60% of the mass of the composite powder, the mixture is stirred evenly, and then injected into a 40×40×40 mm cube mold, the vibration is performed on the vibrator for 2 min to eliminate bubbles, the mold is wrapped with polyvinyl chloride plastic film and placed in a curing box for curing, the curing temperature is 20±2 °C and the humidity is 90±2RH %.

Step 4, maintenance:

The semi-finished product is demoulded after curing for 24 h to obtain the test block, the test block is placed in a water curing box for 3-28 d, and the curing temperature is 20±2 °C. The 3 d compressive strength of the prepared coal gasification slag solid waste cementitious material reaches 17.6 MPa, and the 28 d compressive strength reaches 25.5 MPa, the slump of the prepared cementitious material slurry is 234 mm.

### Example 4

An coal gasification slag all-solid waste cementitious material, including composite powder and water, the composite powder includes calcined coal gasification slag, granulated blast furnace slag, desulfurized gypsum and carbide slag. The calcined coal gasification slag is prepared by mixed calcination of coal gasification coarse slag and coal gasification fine slag at a mass ratio of 6:4. According to the mass ratio, the calcined coal gasification slag:granulated blast furnace slag:desulfurized gypsum:carbide slag=35:45:13:7; the amount of water added is based on the composite powder, which is 40% of the mass of the composite powder.

The preparation method for the coal gasification slag all-solid waste cementitious material includes the following steps:

Step 1, coal gasification slag mixed calcination:

The coal gasification coarse slag and coal gasification fine slag are mixed evenly according to the mass ratio of 6:4, and then placed into a planetary ball mill to grind at a speed of 300 rpm/min for 60 min, the milled material is placed in a mullite crucible in a muffle furnace, heated to 500 °C at a heating rate of 10 °C/min, and then held for 3 h to stop heating. After the material is naturally cooled in the furnace, the calcined coal gasification slag is obtained by using a planetary ball mill to 80 μm.

Step 2, powder mixing:

According to the mass ratio, the calcined coal gasification slag:granulated blast furnace slag:desulfurization gypsum:carbide slag=35:45:13:7; the calcined coal gasification slag, granulated blast furnace slag, desulfurization gypsum and carbide slag are mixed to form a composite powder, and the composite powder is stirred evenly.

Step 3, preparation of the semi-finished product:

Water is added to the composite powder, the mass of water added is 40% of the mass of the composite powder, mixed and stirred evenly, and then injected into a 40×40×40 mm cube mold, vibrated on a vibrator for 2 min to eliminate bubbles, wrapped the mold with polyvinyl chloride plastic film, and placed in a curing box for curing. The curing temperature is 20±2 °C and the humidity is 90±2RH %.

Step 4, maintenance:

The semi-finished product is demoulded after curing for 24 h to obtain the test block. The test block is placed in a water curing box for 3-28 d, and the curing temperature is 20±2 °C. The 3 d compressive strength of the prepared coal gasification slag solid waste cementitious material reaches 26.8 MPa, and the 28 d compressive strength reaches 37.5 MPa, the slump of the prepared cementitious material slurry is 204 mm.

### Example 5

A coal gasification slag solid waste cementitious material, including composite powder and water. The composite powder includes calcined coal gasification slag, granulated blast furnace slag, desulfurized gypsum and carbide slag, the calcined coal gasification slag is prepared by mixing and calcining the coal gasification coarse slag and the coal gasification fine slag at a mass ratio of 6:4. According to the mass ratio, the calcined coal gasification slag:granulated blast furnace slag:desulfurized gypsum:carbide slag=40:40:12:8; the amount of water added is based on the composite powder, which is 50% of the mass of the composite powder.

The preparation method for the coal gasification slag all-solid waste cementitious material includes the following steps:

Step 1, coal gasification slag mixed calcination:

The coal gasification coarse slag and coal gasification fine slag are mixed evenly according to the mass ratio of 8:2, and then placed into the planetary ball mill at a speed of 300 rpm/min for 60 min. The milled material is placed in a mullite crucible in a muffle furnace, heated to 500 °C at a heating rate of 10 °C/min, and then held for 3 h to stop heating. After the material is naturally cooled in the furnace, the calcined coal gasification slag is obtained by using a planetary ball mill to 80 μm.

Step 2, powder mixing:

According to the mass ratio, the calcined coal gasification slag:granulated blast furnace slag:desulfurization gypsum:carbide slag=40:40:12:8. The calcined coal gasification slag, granulated blast furnace slag, desulfurization gypsum and carbide slag are mixed to form a composite powder, and the composite powder is stirred evenly.

Step 3, preparation of the semi-finished product:

Water is added to the composite powder, and the mass of water added is 50% of the mass of the composite powder, the mixture is stirred evenly, and then injected into a 40×40×40 mm cube mold. The mold is vibrated on a vibrator for 2 min to eliminate bubbles, the mold is wrapped with polyvinyl chloride plastic film and placed in a curing box for curing. The curing temperature is 20±2 °C and the humidity is 90±2RH %.

Step 4, maintenance:

The semi-finished product is demoulded after curing for 24 h to obtain the test block, the test block is placed in a water curing box for 3-28 d, and the curing temperature is 20±2 °C. The 3 d compressive strength of the prepared coal gasification slag solid waste cementitious material reaches 28.7 MPa, and the 28 d compressive strength reaches 39.3 MPa, the slump of the prepared cementitious material slurry is 213 mm.

### Example 6 (Control Group)

A coal gasification slag solid waste cementitious material, including composite powder and water, the composite powder includes raw coal gasification coarse slag, granulated blast furnace slag, sodium-based desulfurization ash and carbide slag. According to the mass ratio, raw coal gasification coarse slag:granulated blast furnace slag:sodium-based desulfurization ash:carbide slag=40:40:12:8; the amount of water added is based on the composite powder, which is 50% of the mass of the composite powder.

The preparation method for the coal gasification slag all-solid waste cementitious material includes the following steps:

Step 1, coal gasification slag grinding:

In order to compare the effect of coal gasification slag before and after calcination on the properties of cementitious materials, the raw coal gasification slag is put into a planetary ball mill at a speed of 300 rpm/min for 60 min and ground to 80 μm to obtain mechanically activated coal gasification slag.

Step 2, powder mixing:

According to the mass ratio, the raw coal gasification coarse slag:granulated blast furnace slag:sodium-based desulfurization ash:carbide slag=40:40:12:8. The ground coal gasification coarse slag, granulated blast furnace slag, sodium-based desulfurization ash, and carbide slag are mixed to form a composite powder, and the composite powder is stirred evenly.

Step 3, preparation of the semi-finished product:

Water is added to the composite powder, and the mass of water added is 50% of the mass of the composite powder. The mixture is stirred evenly, and then injected into a 40×40×40 mm cube mold. The mold is vibrated on a vibrator for 2 min to eliminate bubbles. The mold is wrapped with polyvinyl chloride plastic film and placed in a curing box for curing. The curing temperature is 20±2 °C and the humidity is 90±2RH %.

Step 4, maintenance:

After curing for 24 h, the semi-finished product is demoulded to obtain the test block. The test block is placed in a water curing box for 3-28 d, and the curing temperature is 20±2 °C. The 3 d compressive strength of the prepared coal gasification slag solid waste cementitious material reaches 20.5 MPa, and the 28 d compressive strength reaches 30.2 MPa. The slump of the prepared cementitious material is 176 mm. Compared with Example 2, the 3 d and 28 d compressive strength of the cementitious material prepared by the calcined coal gasification slag increases by 24.9% and 20.8%, respectively, and the slump performance increases by 22.2%.

Following Table 1 shows a carbon content test data before and after calcination of coal gasification coarse slag:

TABLE 1
a carbon content test data before and after
calcination of coal gasification coarse slag

| Calcination | | Ash content(%) | | Volatile content(%) | | | Solid |
|---|---|---|---|---|---|---|---|
| temperature(°C) | Moisture(%) | A_{ad} | A_{d} | V_{ad} | V_{d} | V_{daf} | carbon(%) |
| 0 | 2.05 | 86.23 | 88.03 | 2.21 | 2.26 | 18.86 | 9.51 |
| 500 | 0.21 | 99.33 | 99.53 | 0.41 | 0.41 | 88.74 | 0.05 |
| 700 | 0.00 | 100 | 100 | 0.00 | 0.00 | 0.00 | 0.00 |

What is claimed is:

1. A coal gasification slag solid waste cementitious material, comprising a composite powder and water; wherein the composite powder comprises calcined coal gasification slag/coal gasification coarse slag, granulated blast furnace slag, sodium-based desulfurization ash and carbide slag, wherein a preparation method for calcined coal gasification slag without auxiliary fuel is as follows: the coal gasification coarse slag is crushed and mixed with the coal gasification fine slag according to a mass ratio of (6:4)-(8:2), and then placed into a ball mill for grinding for 60 min, a material is calcined at a high temperature, and the material is naturally cooled and ground to less than or equal to 80 μm to obtain the calcined coal gasification slag; a calcination condition is as follows: the material is heated to 400-500 °C at a heating rate of 10-15 °C/min, and then held for 2-3 h; according to the mass ratio, according to a mass ratio, the calcined coal gasification slag/coal gasification coarse slag:granulated blast furnace slag:sodium-based desulfurization ash:carbide slag=(30-40):(40-45):(12-15):(7-10); a mass of water added is 40%-60% of a mass of the composite powder; a specific surface area of the composite powder is 450-530 m²/kg.

2. A preparation method for coal gasification slag without auxiliary fuel according to claim 1, wherein comprising coal gasification coarse slag (carbon content is 10%-20%) and coal gasification fine slag (carbon content is 40%-60%), mixed coal gasification slag without auxiliary fuel is calcined, high content residual carbon in coal gasification fine slag provides calorific value and reduces external energy consumption.

3. A preparation method for the coal gasification slag solid waste cementitious material according to claim 1, wherein it comprises the following steps:
step 1, coal gasification slag calcination treatment:
crushing the coal gasification coarse slag and mixing with the coal gasification fine slag according to a mass ratio, grounding the material for 60 min and calcining at high temperatures, after the material is naturally cooled, grounding the material to less than or equal to 80 μm to obtain the calcined coal gasification slag; the calcination condition is as follows: the material is heated to 400-500 °C at a heating rate of 10-15 °C/min, and then heat preservation is performed for 2-3 h;
step 2, powder mixing:
according to a ratio, mixing the calcined coal gasification slag/coal gasification coarse slag, granulated blast furnace slag, sodium-based desulfurization ash, and carbide slag to form a composite powder, and stirring the composite powder evenly;
step 3, preparation of a semi-finished product:
according to the ratio, adding water to the composite powder, mixing and stirring evenly, then injecting into a mold, vibrating to eliminate bubbles, and then sealing the mold to prevent water evaporation and placing it in a curing box for curing, a curing temperature is 20±2 °C and a humidity is 90±2 RH %;
step 4, maintenance:
demoulding the semi-finished product after curing to obtain a test block, placing the block in a water curing tank for curing, a 3 d compressive strength of a coal gasification slag all-solid waste cementitious material prepared is up to 30.6 MPa, and a 28 d compressive strength is up to 45.5 MPa.

4. The preparation method for the coal gasification slag solid waste cementitious material according to claim 3, wherein in Step 4, a curing temperature is 20±2 °C and a curing time is 3-28 d.
